(19) United States
(12) Patent Application Publication
(10) Pub. No.: US 2014/0043870 A1
(43) Pub. Date: Feb. 13, 2014

(54) THREE PHASE BOOST CONVERTER TO ACHIEVE UNITY POWER FACTOR AND LOW INPUT CURRENT HARMONICS FOR USE WITH AC TO DC RECTIFIERS

(71) Applicant: Mahesh M. Swamy, Gurnee, IL (US)

(72) Inventor: Mahesh M. Swamy, Gurnee, IL (US)

(73) Assignee: Yaskawa America, Inc.

(21) Appl. No.: 13/568,498

(22) Filed: Aug. 7, 2012

(51) Int. Cl. H02M 7/06; H02M 5/44

(52) U.S. Cl. 363/36; 363/126

(57) ABSTRACT

A voltage source inverter comprises a zigzag transformer providing a neutral point. A rectifier unit comprises three single phase boost converters each connected to one of the three phases of AC power and the neutral point and comprising a bridge rectifier converting single phase AC power to DC power and using a boost inductor with a boost switch and blocking diode to develop a DC output. An inverter receives DC power and converts DC power to AC power. A link circuit is connected between each boost converter DC output and the inverter circuit and comprises a DC bus having first and second rails to provide a relatively fixed DC voltage for the inverter and a DC bus capacitance across the first and second rails to smooth voltage ripple. A switch controller controls operation of the boost switches using average current control for each of the boost converters.

### CROSS-REFERENCE TO RELATED APPLICATIONS

Not Applicable.

### FEDERALLY SPONSORED RESEARCH OR DEVELOPMENT

Not Applicable.

### MICROFICHE/COPYRIGHT REFERENCE

Not Applicable.

### FIELD OF THE INVENTION

This invention relates to AC to DC rectifiers and, more particularly, to a boost converter to achieve unity power factor with low input current harmonics.

### BACKGROUND

Typical voltage source inverter based variable frequency drives (VFDs) have an AC to DC rectifier unit with a large DC bus capacitor to smooth the voltage ripple. The DC bus capacitor draws charging current only when it is discharged in to the motor load. The charging current flows into the DC bus capacitor when the input rectifier is forward biased, which occurs when the instantaneous input voltage is higher than the DC voltage across the DC bus capacitor. The pulsed current drawn from the AC source is rich in harmonics because it is discontinuous. This type of nonlinear current flow is associated with poor input power factor. The power delivery equipment is also subject to unnecessary power loss and the overall system efficiency suffers. In light of the above mentioned problems, it is worthwhile to suggest power topologies to help improve the input power factor and lower the input current distortion thereby increasing the system efficiency.

There are many techniques, both passive and active, that are employed to improve the current waveform and reduce the overall current harmonics. The active techniques have an advantage over the passive techniques from size and performance viewpoints. However, the cost of certain type of active techniques can be higher than passive techniques.

The present invention, as disclosed in the detailed description below, employs boost converters in a manner that lends itself to easy integration and for applying to high power applications. A basic prior circuit for a single-phase boost converter application is shown in FIG. 1. The topology shown in FIG. 1 employs a boost inductor with a boost switch and a blocking diode. In a variation of this circuit, shown in FIG. 2, two single-phase boost converters, with 180 degree phase shifted pulses, are employed to reduce the ripple across the DC bus capacitor, thereby improving its reliability and reducing its loss. Such a boost topology is also known as “Interleaved Boost Converter” or “Dual Boost Converter”. Light load or partial load efficiency has been shown to be improved by staging on and off one of the boost converter at light loads to improve the system efficiency. EMI filtering techniques have also been suggested to reduce conducted EMI when synchronized dual boost converters are in operation. Loss optimization has also been performed using the dual boost converter by switching one of the boost converter at high frequency and low current and the other at low frequency and higher current levels. Different boost inductor types may be employed to optimize efficiency since each boost converter operates independently at different switching frequency.

The boost converter circuits shown in FIGS. 1 and 2 rely on the boost action provided by the inductor in the DC bus. The boost action can also be achieved using input AC inductors and semiconductor switches in place of diodes in the AC to DC rectifier circuit. Such a bridgeless topology is disclosed in U.S. Pat. No. 4,412,277. Many different variations of the AC side boost converter have been put forth hence and are well reported in the literature. Such topologies have been extensively studied and implemented in residential and commercial markets for use in various single-phase AC to DC rectifiers.

An advantage of the bridgeless topology is that at any given instant of time only two semiconductors conduct current—a switch and a diode or two diodes; whereas in the traditional boost, converter of FIG. 1, at any given instant of time, three semiconductors are operating—either two diodes and a semiconductor switch or three diodes. This reduces power loss in the boost converter thereby improving system efficiency. In addition, the DC inductor needs to be designed to handle the DC component that can make it bulky. The AC inductors can be made smaller since the flux in the core is not unidirectional. Further, the input AC inductor also helps reduce conducted Electro Magnetic Interference (EMI) noise.

In the standard bridgeless topology, the control requires sensing the input current through both of the boost inductors. This can be an involved process. An intelligent way of sensing both of the input currents using only one current sensor has also been used in product offerings.

The operation of a standard single phase boost converter is explained here using an equivalent circuit shown in FIG. 3. Single phase input AC supply is rectified and fed into the DC bus. The switch S1 is turned ON and OFF rapidly creating a chopping effect of the DC bus voltage and hence sometimes the circuit is also known as a “chopper”. When the switch S1 is turned ON, the output of the rectifier is shorted and the current is limited by the DC link inductor. During this time, energy is stored in the DC link inductor. When the switch S1 is turned OFF, the inductor current cannot stop flowing immediately because of the nature of inductance. The voltage across the inductor increases and forward biases the blocking diode and all its stored energy is transferred to the DC bus capacitor and the load. The DC bus voltage hence is boosted up from its previous voltage value. Depending on the duration for which the switch S1 remains closed, the energy stored in the boost inductor can be significant and when the switch S1 is turned OFF, all of the energy is transferred quickly to the DC bus capacitor thereby significantly boosting up its voltage. Hence, the boost voltage value depends on the turn ON duration of the switch S1 and the value of the inductance of the boost inductor. The switching ON and OFF of the switch S1 takes place very rapidly (in kHz range) and hence the output DC bus voltage is held more or less constant. However, due to the single phase nature of the circuit in FIG. 1, it is difficult to completely remove the low frequency 120 Hz oscillations across the DC bus, especially when the load across the DC bus capacitor increases.

FIG. 4 illustrates the operation when the switch S1 is closed, labeled Mode 1, and when the switch S1 is open, labeled Mode 2. In Mode 1, when the switch S1 is ON, current flows through the inductor L_{DC} into the switch S1. The input voltage Vrec is applied across the input inductor L_{DC} and the inductor current increases linearly. In the meantime, the voltage across the blocking diode D is such that it is reverse biased and blocks flow of current through it. The energy stored in the capacitor C_{DC} is discharged into the load, R_{LOAD} and hence the voltage across the capacitor C_{DC} falls down. If the load is resistive in nature, then the discharge of the capacitor C_{DC} into a resistive load will follow a standard inverse exponential form. However, if the load is a constant current source, similar to that observed for an electric motor, the discharge current is constant, which makes the discharge voltage of the capacitor linear.

When the switch S1 is turned off, Mode 2 begins. Since the current through the inductor L_{DC} cannot abruptly cease to flow, it maintains its flow by forward biasing the blocking diode D. The capacitor C_{DC} gets charged since the energy in the inductor L_{DC} transfers to the capacitor C_{DC} and so the capacitor voltage starts to increase. A part of the inductor current flows into the load as well. The voltage across the inductor L_{DC} is negative during this period since the input voltage is lower than the DC bus voltage. This has to be true since the average voltage across an inductor is always zero.

Based on the discussions thus far, the waveforms at important points in the boost converter can now be confirmed, as shown in FIG. 5.

The output voltage is a function of the duty cycle ‘α’ of the switch S1. The relationship between the average output voltage V_{DC} and the average input voltage V_{rec} in terms of the duty cycle α is derived next. If the switch S1 is ON for duration t_{ON}, and has a cycle duration of T, then duty cycle α is defined as:

$$α = \frac{{t}_{ON}}{T} \qquad ( 1 )$$

Since the average voltage across the inductor is zero, the following expression is true:

$$( α T \cdot {V}_{rec} ) + ( ( 1 - α ) T \cdot ( {V}_{rec} - {V}_{DC} ) = 0 \\ α = 1 - \frac{{V}_{rec}}{{V}_{DC}} \qquad ( 2 )$$

The average output voltage V_{DC} in terms of the average input voltage V_{rec} and duty ratio α is given as:

$${V}_{DC} = \frac{{V}_{rec}}{1 - α} \qquad ( 3 )$$

When the duty cycle α is zero, then the average output voltage is the same as the average input voltage because the switch S1 is not being utilized. If the duty ratio α is 1, then the output voltage can theoretically go to infinity, which is impractical. Since the output DC voltage V_{DC} is greater than the input rectified voltage Vrec, for all practical values of α, the circuit of FIG. 1 is referred to as a boost converter.

Because of the boost action, during loaded operating condition, current flows through the input terminals irrespective of the fact that there exists a DC bus capacitor. By modulating the switching duty cycle a, to follow the input AC voltage, the input current can be made sinusoidal. In other words, the input power factor can be significantly improved and the input current distortion can be reduced.

Average current control is a popular method to regulate the output DC voltage in a boost converter and simultaneously achieve low input current harmonics. Problems of crossover distortion in complete sensing schemes such as current programmed control can be avoided. The current I_{LDC} through the inductor L_{DC}, is considered to be the best choice for average current control. The reasons are as follows: the phase of I_{LDC} with respect to the rectified output voltage has information necessary to achieve unity power factor; and the amplitude of I_{LDC} has information pertaining to the operating power condition.

Hence, the current I_{LDC} is considered to be the choice parameter for average current control. The reference current equation can be derived from the power balance condition. The average input power should be equal to the average output power neglecting the loss in the DC link inductor L_{DC} and the switch S1. Using this condition, the following relationship is obtained:

$$\begin{matrix}{P}_{avg} = \frac{{V}_{in}^{2}}{{R}_{e}} = \frac{{V}_{in}^{2} \cdot {I}_{I . DC}^{*}}{{V}_{rec}} \\ {I}_{LDC}^{*} = \frac{{P}_{avg} \cdot {V}_{rec}}{{V}_{in}^{2}} = \frac{{V}_{DC} \cdot {I}_{LOAD} \cdot {V}_{rec}}{{V}_{in}^{2}} & ( 4 ) \\ {I}_{LDC}^{*} ∝ \frac{{V}_{DC} \cdot {V}_{rec}}{{V}_{in}^{2}} ∝ \frac{A \cdot B}{C} & ( 5 )\end{matrix}$$

In the above equations, Re is the effective and programmable load resistance. The load current I_{LOAD} is assumed constant so that the reference current generation I*_{LDC} requires knowledge of the desired regulated DC bus voltage (A), the instantaneous value of the input rectified voltage Vrec that has the phase information (B) and the square of the rms value of the input AC voltage (C). The importance of the C term is visible from the point of power. For a given power rating, if the input AC voltage is high, then the input current amplitude should automatically be reduced as square, of the input ac voltage.

A controller IC, such as the model UC3854, that has all the features described thus far to facilitate unity power-factor operation with low input current distortion is popularly used in many commercially available boost converters. The theoretical waveforms on a supply frequency time scale are shown in FIG. 6.

In the schemes discussed thus far, the topology assumes that the input AC source is of single phase type. Hence, in all cases, the load level is typically less than or equal to a maximum value of 3.7 kW. When the load power increases beyond this value, it is customary to adopt three-phase input AC supply. Many local and municipal codes do not allow operation of larger power loads via a single phase AC source. A three phase version of the standard boost topology has been studied. There is need for a neutral point source. In other words, a three phase, four-wire system is needed for proper operation of such known circuits. Such circuits also attempt to achieve zero voltage transition (ZVT) to reduce the overall loss in the power stage.

One known topology uses two single-phase boost converters in an asymmetrical manner to achieve high power factor and low input current distortion at the input 3-phase AC supply. By converting the input three phases to just two phases using an autotransformer low input current and high input power factor may be achieved using only two boost converters. One of the drawbacks is that there is unbalanced current flowing in the input of the rectifier modules since the gains of the two boost converters are modified such that the power being supplied from each of the two boost converters is exactly one-half of the total load power. Since the current flowing in the two boost converters are different because the power balance needs to be maintained, there is need for two independent current sensors for independently controlling the two boost converters. The two boost converters can share the same voltage feedback information since both these units need to control the same dc bus voltage.

The present invention addresses the need for a three phase boost converter in a three phase 4-wire system,

### SUMMARY

This application describes a low cost active circuit that is based on employing three single phase boost converters. Since the need to improve input power factor and reduce input current harmonic distortion is more important in high power AC to DC rectifiers typically forming the front end of high power Variable Frequency Drives (VFDs), it is necessary to address power factor and harmonic problems in such applications.

In one aspect there is disclosed a voltage source inverter comprising a zigzag transformer for receiving three phase AC power from an AC source and providing a neutral point. A rectifier unit comprises three single phase boost converters each connected to one of the three phases of AC power and the neutral point and comprising a bridge rectifier converting single phase AC power to DC power and using a boost inductor with a boost switch and blocking diode to develop a DC output. An inverter receives DC power and converts DC power to AC power. A link circuit is connected between each boost converter DC output and the inverter circuit and comprises a DC bus having first and second rails to provide a relatively fixed DC voltage for the inverter and a DC bus capacitance across the first and second rails to smooth voltage ripple. A switch controller controls operation of the boost switches using average current control for each of the boost converters.

There is disclosed in accordance with another aspect of the invention a three phase boost converter system comprising a zigzag transformer for receiving three phase AC power from an AC source and providing a neutral point. A rectifier unit comprises three single phase boost converters each connected to one of the three phases of AC power and the neutral point and comprising a bridge rectifier converting single phase AC power to DC power and using a boost inductor with a boost switch and blocking diode to develop a DC output. A link circuit is connected to each boost converter DC output and comprises a DC bus having first and second rails to provide a relatively fixed DC voltage for a load comprising DC/AC converters fed from a common DC voltage source with each DC/AC converter having a DC bus capacitor to smooth voltage ripple. A switch controller controls operation of the boost switches using average current control for each of the boost converters.

It is a feature of the invention that the switch controller senses current through the boost Conductor of each boost converter.

Three current sensors may be provided, one for each boost, converter, and the sensed currents may be summed as an average current input of the switch controller. Alternatively, a single current sensor may sense current through each boost inductor as an average current input to the switch controller.

It is a further feature that the switch controller is connected to the DC link to sense DC voltage for each, of the boost converters.

It is another feature that the switch controller senses bridge rectifier DC output for each boost converter.

It is still a further feature that the switch controller controls duty cycle of each boost switch to maintain desired average current.

It is yet another feature that the switch controller monitors ripple current and reduces the conduction duration if the ripple current increases.

Other features and advantages will be apparent from a review of the entire specification, including the appended claims and drawings.

### BRIEF DESCRIPTION OF THE DRAWINGS

FIG. 1 is an electrical schematic for a prior art single phase boost converter;

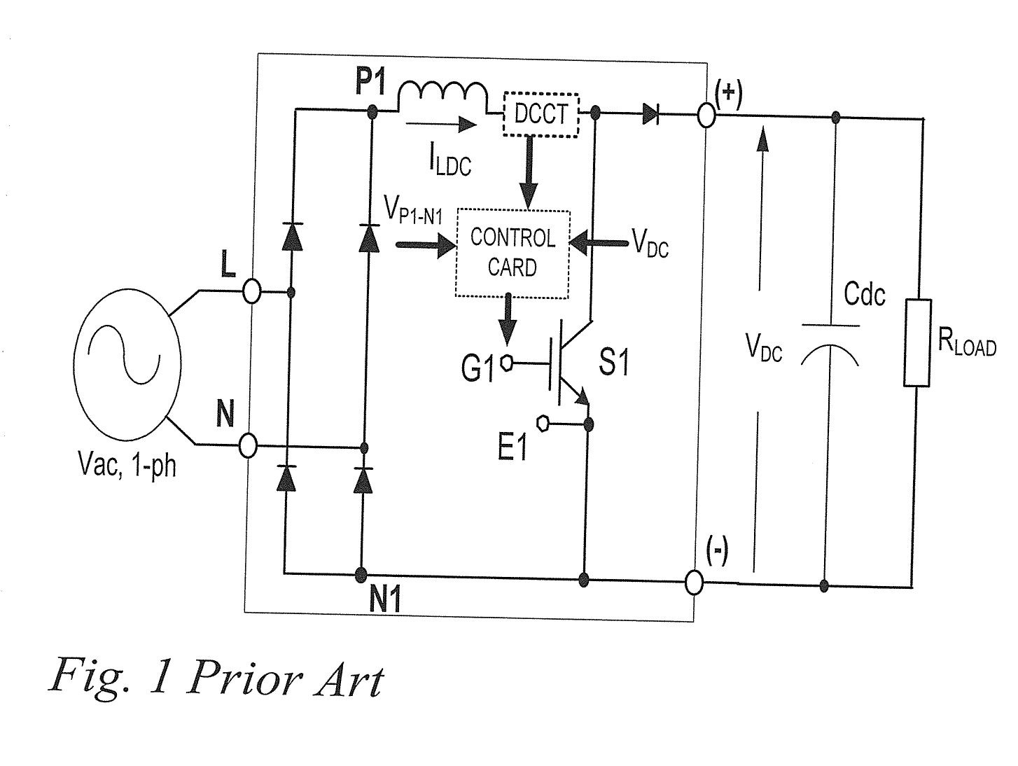

FIG. 2 is a schematic for a prior art dual boost converter;

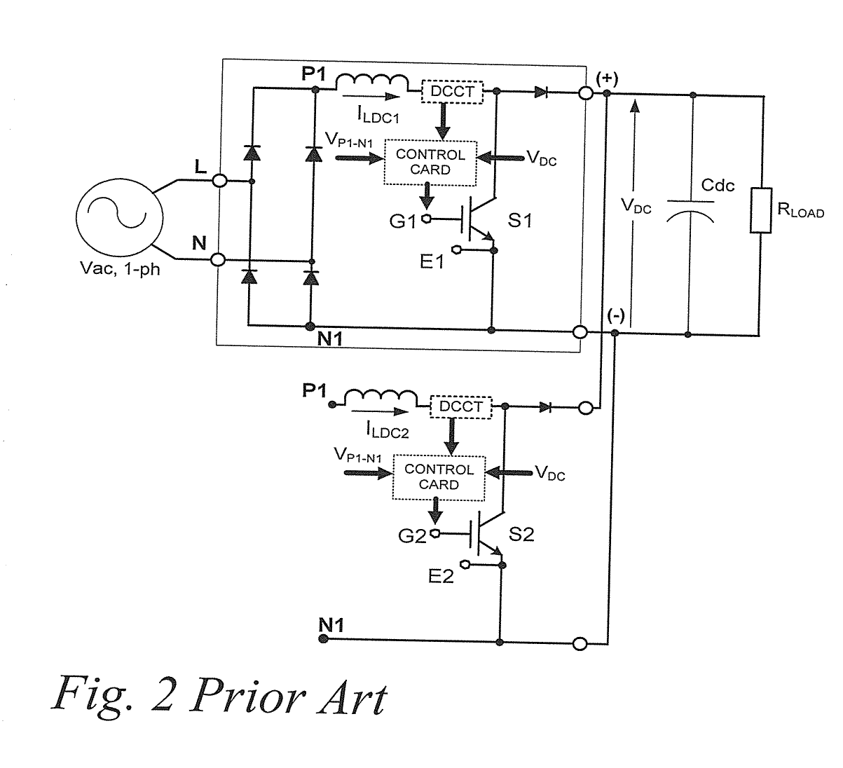

FIG. 3 is an equivalent circuit for the circuit shown in FIG. 1;

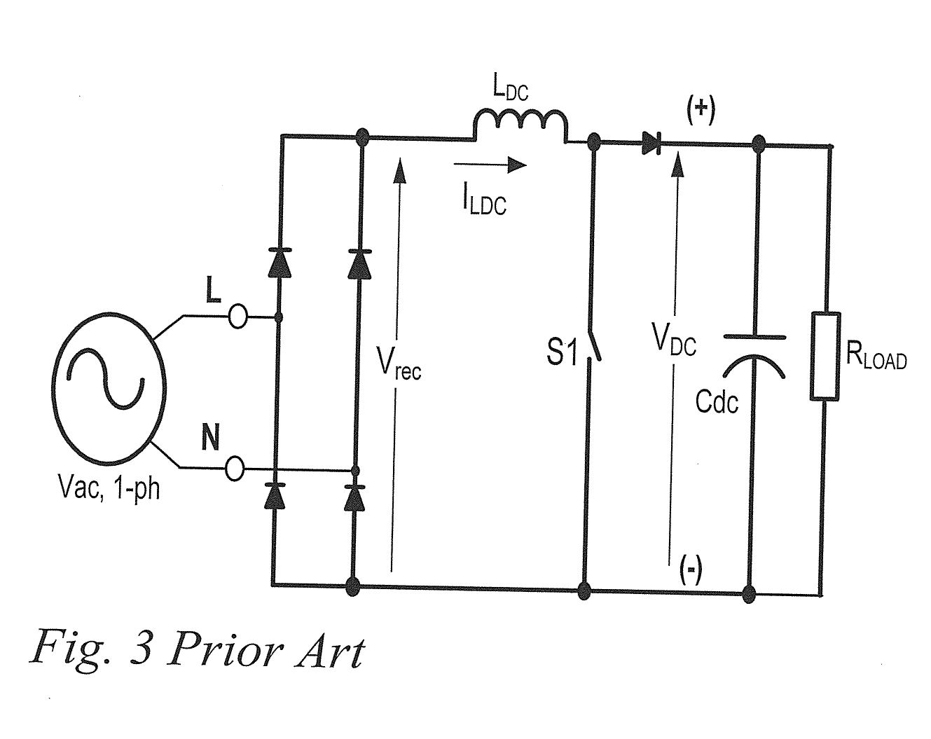

FIG. 4 illustrates modes of operation of the equivalent circuit of FIG. 3;

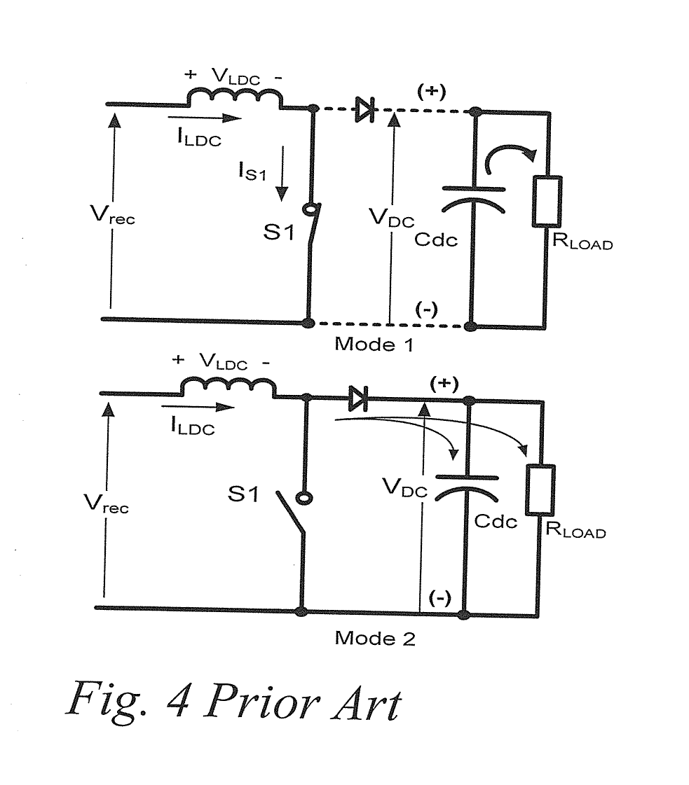

FIG. 5 illustrates waves formed at points in the boost converter of FIG. 1;

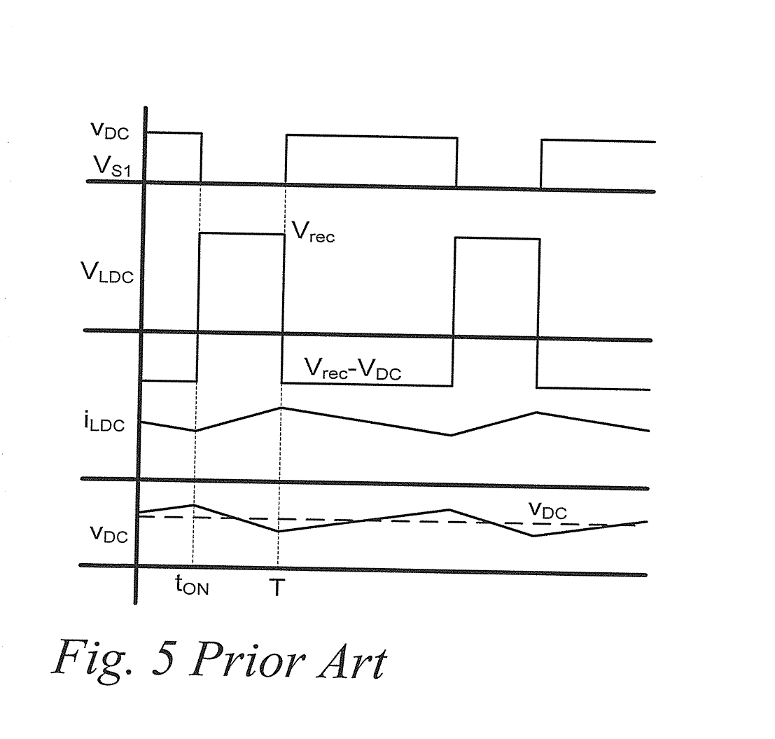

FIG. 6 illustrates voltage wave forms for the schematic of FIG. 1;

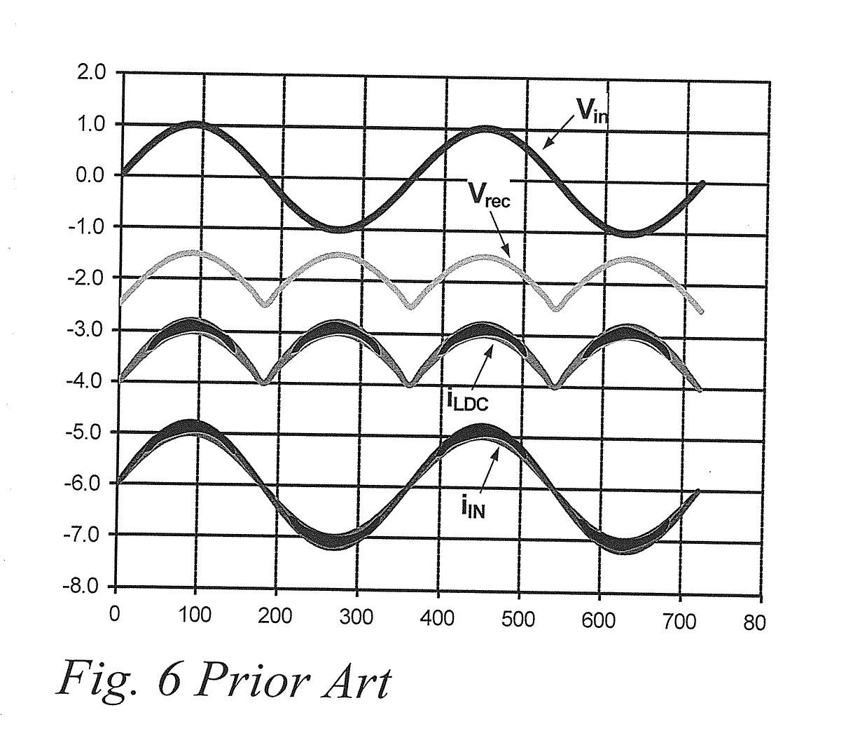

FIG. 7 is an electrical schematic of a boost converter system in accordance with a first embodiment of the invention;

FIG. 8 is an electrical schematic of a boost converter system in accordance with a second embodiment of the invention; and

FIG. 9 is an electrical schematic of a boost converter in accordance with a third embodiment of the invention.

### DETAILED DESCRIPTION

As described below, a VFD uses three single phase boost converters that are balanced under steady state conditions and share the power equally among them. In other words, if the load power is PLOAD, then each boost converter will be required to process power corresponding to only PLOAD/3. The disclosed topology will not require use of a 3 phase, 4-wire source. Instead, the neutral point is obtained from an existing 3 phase supply using a zigzag transformer. Since the neutral currents are balanced and they cancel each other out, the actual neutral current flowing into the zigzag neutral is zero. This reduces the size of the zigzag transformer dramatically. A zigzag transformer rated to handle only a low magnetizing current will suffice. Typically, the VA rating of the zigzag transformer in the disclosed topology will be less than or equal to 0.08 pu.

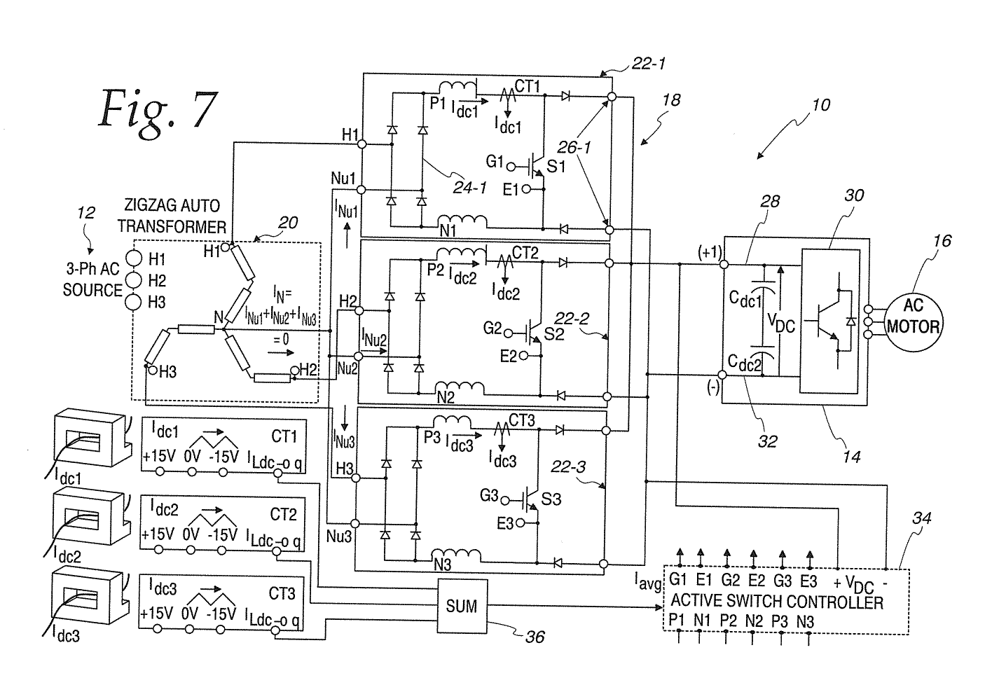

Referring particularly to FIG. 7, a motor drive system 10 is illustrated. The motor drive system 10 receives power from an AC source 12 and includes a variable frequency drive (VFD) 14 configured as a voltage source inverter for driving an induction motor 16. As is known, a control unit (not shown) would be used for controlling the VFD 14. However, such a control unit is not shown herein as it does not itself form part of the invention. Instead, the invention is particularly directed to a three phase boost converter system 18, as described below.

The AC source 12 may comprise a drive or the like developing three phase AC power using three wires which are connected to terminals H1, H2 and H3 of a zigzag auto transformer 20. The zigzag auto transformer 20 may be of conventional construction and provides a neutral point N. As indicated, the current flowing into the zigzag neutral N is zero.

The boost converter system 18 is in the form of a rectifier unit comprising three single phase boost converters 22, individually labeled as 22-1, 22-2 and 22-3. Each single phase boost converter 22 is of identical construction.

The first single phase boost converter 22-1 comprises a bridge rectifier 24-1 connected to the first phase terminal. H1 and the neutral point N for converting AC power to DC power across a high side node P1 and a low side node N1. Boost inductors L_{DC1+} and L_{DC1-} are connected to the respective points P1 and N1 and to blocking diodes D1+ and D1−. A switch S1 is connected across the junction between the respective inductors L_{DC1+} and diode D1+ and L_{DC1-} and diode D1−. The switch S1 includes terminals G1 and E1 for controlling operation thereof. The single phase boost converter 22-1 develops DC power at a DC output formed by output nodes 26-1. A current sensor CT1 senses current through the boost inductor L_{DC1+}.

The second and third single phase boost converters 22-2 and 22-3 are of identical construction and are not described in detail herein.

The DC outputs of the three single phase boost converters 22 are connected by a DC link circuit 28 to an inverter 30. The DC link circuit 28 comprises a DC bus 32 having first and second rails + and − to provide a relatively fixed DC voltage for the inverter 30. A DC bus capacitance formed by capacitors C_{DC1} and C_{DC2} is across the first and second rails to smooth voltage ripple.

An active switch controller 34 controls operation of the boost switches S1, S2 and S3 using average current control. The inputs to the active switch controller comprise the input DC voltages at terminals P1 and N1 for the first boost converter 22-1, and similar terminals P2 and N2 for the second boost converter 22-2 and P3 and N3 for the third boost converter 22-3. The active switch controller 34 has a single voltage input comprising voltage across the DC bus 32. The current through the three current transformers CT1, CT2 and CT3 are summed at a summer 36 to provide an average current input to the active switch controller 34.

The active switch controller 34 comprises three separate control integrated circuits to generate the necessary gating pulses at terminals G1 and E1, G2 and E2, G3 and E3, for the three single phase boost converters 22-1, 22-2 and 22-3, respectively. The integrated circuits may be, for example, UC1854 type high power factor preregulators. These implement average current control operation to regulate output DC voltage, as discussed above.

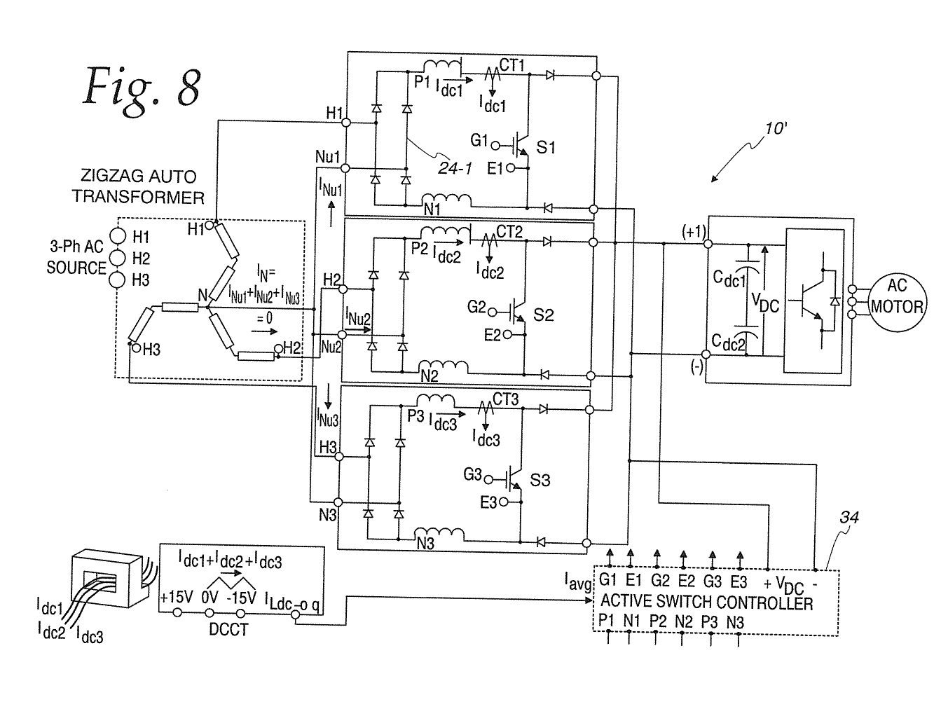

FIG. 8 illustrates a schematic for a motor drive system 10 generally similar to the motor drive system 10 of FIG. 7. The difference in this embodiment is that the circuit uses a single coil for current sensors CT1, CT2 and CT3 to provide a direct average current input to the active switch controller 34. Otherwise, the operation is the same.

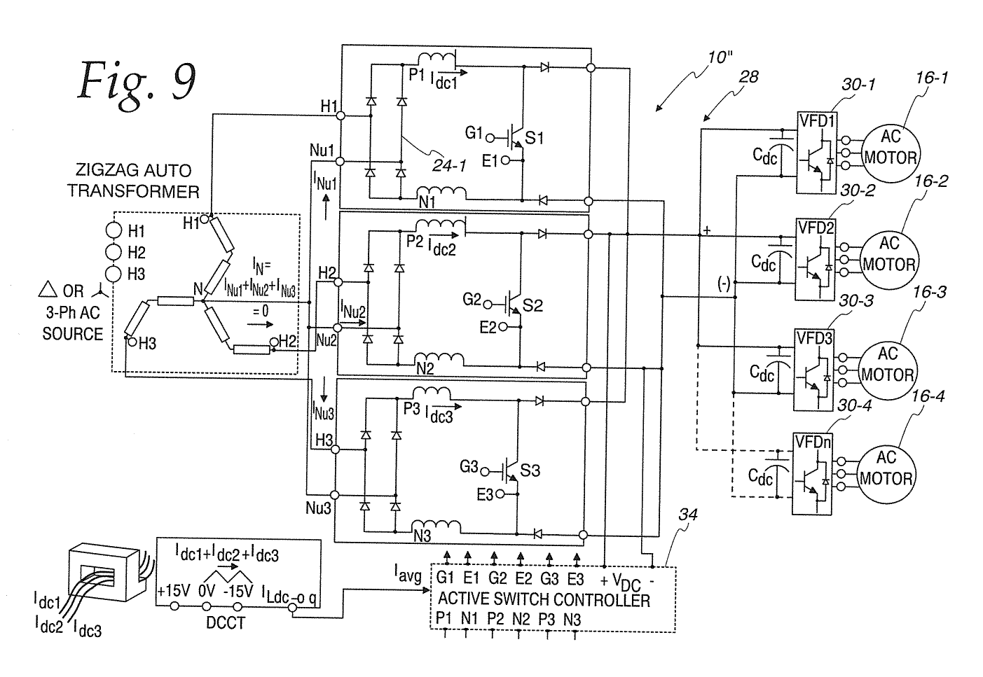

FIG. 9 illustrates an electrical schematic for a motor drive system 10″ for a load comprising plural DC/AC inverters 30-1, 30-2, 30-3 and 30-4 fed from a common DC voltage source. In this instance, each inverter has a DC bus capacitor C_{dc} to smooth voltage ripple. As is apparent, any number of inverters could be used according to the particular requirements and available power.

The salient features of the disclosed topology are listed below:
There is no need for a 3 phase, 4-wire source for the system to function satisfactorily in order to improve the input power factor and reduce the input current harmonic distortion when used with Variable Frequency Drive (VFD) loads;
A zigzag transformer 20 is used in order to provide a stable neutral reference point. The actual neutral current is the sum of the neutral currents, I_{NU1}+I_{NU2}+I_{NU3} and this is effectively zero since these currents are balanced and phase shifted by 120 electrical degrees;
The VA rating of the zigzag transformer 20 need be only sufficient to handle the magnetizing current that could be as high as 0.08 pu;
The future of Power Electronics is moving towards employing high speed, high voltage semiconductor devices that can handle high operating temperature. The disclosed topology lends itself very well for employing high speed semiconductor devices thereby realizing huge potential in size reduction of the boost inductor as well as size reduction for the zigzag transformer;
There are three separate control ICs to generate the necessary gating pulses for the three single phase boost converters 22. The imperfections of the input AC source will thus be sensed by the controller 34 and the corresponding pulses will be generated to reduce the input current harmonic distortion; and
A single voltage sensor will suffice.

Since the current is equally shared by the three single phase boast converters 22, only one current sensor DCCT, see FIG. 8, may be required, with the current of each boost inductor going through it. This will reduce cost, increase reliability, and save on space.

By providing an ability to feed DC power to the VFD load, common DC bus configuration is easily achievable as shown in the system configuration in FIG. 9.

From the discussions put forth above, the advantages of the disclosed system, include the system achieves low input current distortion and improves the true input power factor by employing three single phase boost converters without the need for a three phase, 4-wire system. The disclosed system employs a zigzag transformer to provide a stable neutral point needed for satisfactory operation of the three single phase boost converters. The use of a zigzag transformer also helps reduce preexisting imbalance in the three phase AC system by providing a path for the imbalance components to flow into the autotransformer and cancel each other out. The balanced neutral currents from the three single phase boost converters are balanced and phase shifted by 120 electrical degrees, thereby cancelling each other out. This fact reduces the VA rating of the zigzag autotransformer, which is needed to only accommodate the magnetizing current. A typical VA rating of the zigzag autotransformer is proposed to be 0.08 pu or less. Since the three boost converters feed a common load, the power and current rating of the boost converters are balanced and of the same value. This allows the currents of each boost converter to go through a common single current sensor for processing and control. This feature saves cost, space, and improves reliability. Since the outputs of the boost converter feed into a common load, it is easy to implement this topology for common DC bus application as has been disclosed here.

It will be appreciated by those skilled in the art that there are many possible modifications to be made to the specific forms of the features and components of the disclosed embodiments while keeping within the spirit of the concepts disclosed herein. Accordingly, no limitations to the specific forms of the embodiments disclosed herein should be read into the claims unless expressly recited in the claims. Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A voltage source inverter comprising:
a zigzag transformer for receiving three phase AC power from an AC source and providing a neutral point;
a rectifier unit comprising three single phase boost converters, each boost converter connected to one of the three phases of AC power and the neutral point and comprising a bridge rectifier converting single phase AC power to DC power and using a boost inductor with a boost switch and blocking diode to develop a DC output;
an inverter for receiving DC power and converting DC power to AC power;
a link circuit connected between each boost converter DC output and the inverter circuit and comprising a DC bus having first and second rails to provide a relatively fixed DC voltage for the inverter, and a DC bus capacitance across the first and second rails to smooth voltage ripple; and
a switch controller controlling operation of the boost switches using average current control for each of the boost converters.

2. The voltage source inverter of claim 1 wherein the switch controller senses current through the boost inductor of each boost converter.

3. The voltage source inverter of claim 2 wherein three current sensors are provided, one for each boost converter and the sensed currents are summed as an average current input to the switch controller.

4. The voltage source inverter of claim 2 wherein a single current sensor senses current through each boost inductor as an average current input to the switch controller.

5. The voltage source inverter of claim 1 wherein the switch controller is connected to the DC link to sense DC voltage for each of the boost converters.

6. The voltage source inverter of claim 1 wherein the switch controller senses bridge rectifier DC output for each boost converter.

7. The voltage source inverter of claim 1 wherein the switch controller controls duty cycle of each boost switch to maintain desired average current.

8. The voltage source inverter of claim 1 wherein the switch controller monitors ripple current and reduces the conduction duration if the ripple current increases.

9. A boost converter system comprising:
a zigzag transformer for receiving three phase AC power from an AC source and providing a neutral point;
a rectifier unit comprising three single phase boost converters, each boost converter connected to one of the three phases of AC power and the neutral point and comprising a bridge rectifier converting single phase AC power to DC power and using a boost inductor with a boost switch and blocking diode to develop a DC output;
a link circuit connected to each single pause boost converter DC output and comprising a DC bus having first and second rails to provide a relatively fixed DC voltage for a load comprising plural DC/AC converters fed from a common DC voltage source with each DC/AC converter having a DC bus capacitor to smooth voltage ripple; and
a switch controller controlling operation of the boost switches using average current, control for each of the single phase boost converters.

10. The boost converter system of claim 9 wherein the switch controller senses current through the boost inductor of each single phase boost converter.

11. The boost converter system of claim 10 wherein three current sensors are provided, one for each single phase boost converter and the sensed currents are summed as an average current input to the switch controller.

12. The boost converter system of claim 10 wherein a single current sensor senses current through each boost inductor as an average current input to the switch controller.

13. The boost converter system of claim 9 wherein the switch controller is connected to the DC link to sense DC voltage for each of the single phase boost converters.

14. The boost converter system of claim 9 wherein the switch controller senses bridge rectifier DC output for each boost converter.

15. The boost converter system of claim 9 wherein the switch controller controls duty cycle of each boost switch to maintain desired average current.

16. The boost converter system of claim 9 wherein the switch controller monitors ripple current and reduces the conduction duration if the ripple current increases.
